(19) United States
(12) Patent Application Publication
(10) Pub. No.: US 2026/0246417 A1
(43) Pub. Date: Aug. 20, 2026

(54) ANCHOR OPTIMIZED GROUND MOUNTED SOLAR ARRAY

(71) Applicant: Pegasus Solar Inc, Richmond, CA (US)

(72) Inventors: Erich Kai Stephan, Richmond, CA (US); Ian Wogan, Richmond, CA (US)

(21) Appl. No.: 19/542,507

(22) Filed: Feb. 17, 2026

Related U.S. Application Data
(60) Provisional application No. 63/758,942, filed on Feb. 14, 2025.

(51) Int. Cl. H02S 20/30

(52) U.S. Cl. CPC H02S 20/30

(57) ABSTRACT

Embodiments of an apparatus for securing solar modules at variable angles relative to a terrain comprising a module clip and a swivel bracket are described herein. The module clip may include a first side wall and a second side wall that includes one or more solar module flange apertures each configured to receive a solar module flange, a hem that joins the first side wall and the second side wall at an angle, and one or more tabs. The swivel bracket is configured to support a solar module. The swivel bracket may include bracket walls through which an aperture extends, the aperture configured to receive the module clip when the module clip is in the compressed state and to retain the module clip when the module clip is in the uncompressed state, wherein the module clip is secured to an underside of the swivel bracket by the tabs.

### CROSS-REFERENCE TO RELATED APPLICATIONS

The present patent application claims the priority benefit of U.S. provisional patent application number 63/758,942 filed Feb. 14, 2025, the disclosure of which is incorporated by reference herein.

### BACKGROUND OF THE INVENTION

### Field of the Related Art

The present invention generally relates to solar module systems. More specifically, the present invention relates to mounting solar modules on different terrains.

### Description of the Related Art

Currently, solar modules are supported at an angle relative to the horizon set by the geometry of a support bracket and underlying substructure. Often these use excessive materials to support the solar energy modules, support the solar energy module in a way that can compromise its strength, and are unable to follow the contour of the underlying terrain. The present invention is a system that supports solar energy modules at an optimal angle for total energy capture from the sun over the duration of a day while accommodating the contours of the underlying terrain in order to minimize any adaptations to the terrain.

### SUMMARY OF THE CLAIMED INVENTION

Embodiments of the present invention may include solar module arrays and methods for installing the same. The solar module arrays include a plurality of different micropiles and a plurality of solar modules each subject to different pressures and mounted on a terrain by the micropiles. Each of the micropiles may support one or more of the solar modules and is installed in the terrain in accordance with the pressures associated with the respective set of solar modules being supported.

### BRIEF DESCRIPTION OF THE DRAWINGS

FIG. 1 is an exploded isometric view of components of a solar module mounting system.

FIG. 2 is an isometric view of solar module array.

FIG. 3A is a side view of a solar module array.

FIG. 3B is a close-up side view of a solar module array.

FIG. 4 is a side view of a solar module array.

FIG. 5 is a top-down view of a solar module array.

FIG. 6 is a top-down close up view of a corner of a solar module array.

FIG. 7 is a top-down close-up view of a solar module array.

FIG. 8 is a top-down view of a solar module array.

FIG. 9 is a top-down view of a corner of a solar module array.

FIG. 10 is an isometric view of a solar module array.

FIG. 11 is a top-down view of a solar module array.

FIG. 12 is a side view of a solar module array.

FIG. 13 is a close-up side view of a solar module array.

FIG. 14A is an isometric view of an anchor base assembly.

FIG. 14B is a top-down view of an anchor base assembly.

FIG. 15A is a side view of a base installed on a micropile.

FIG. 15B is an isometric view of a base installed on a micropile.

FIG. 16 is an isometric view of a micropile.

FIG. 17 is an isometric view of a micropile.

FIG. 18 is an isometric view of an alternative embodiment of a micropile.

FIG. 19 is an isometric view of an alternative embodiment of a micropile.

FIG. 20 is a close-up isometric view of a distal end of a micropile.

FIG. 21 is a top-down view of four installed adjacent solar module arrays.

FIG. 22 is a top-down view of exemplar arrangement of a plurality of solar module arrays.

FIG. 23 is a top-down view of exemplar arrangement of a plurality of solar module arrays.

FIG. 24 is an isometric view of a solar module array.

FIG. 25 is a top-down view of a solar module array.

FIG. 26 is a top-down close-up view of a corner of a solar module array.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

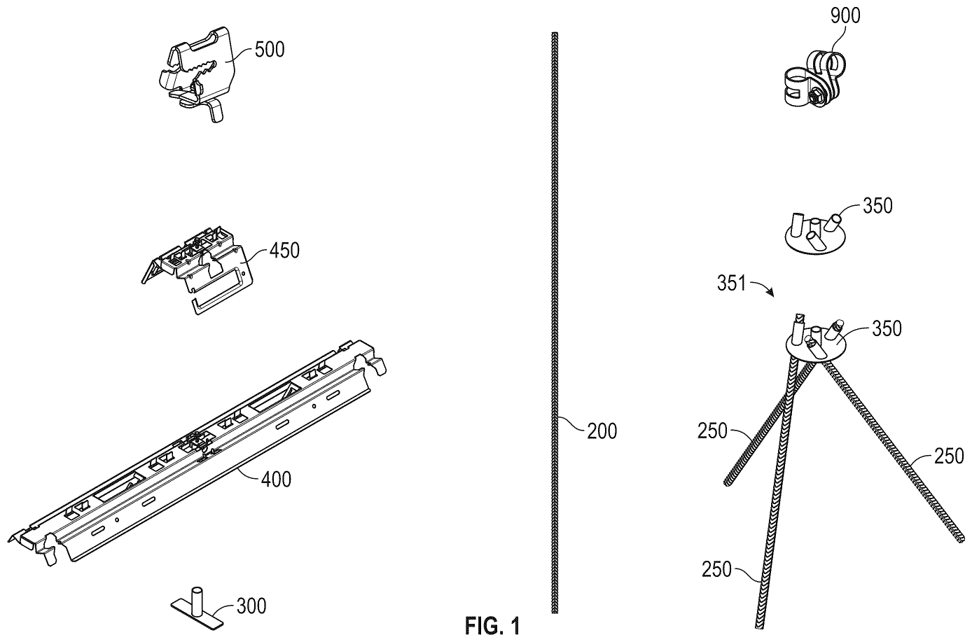

FIG. 1 depicts a collection of components used to support one or more solar modules, representing one example embodiment of the present invention. The set of components may include a plurality of micropiles 200, a base 300, an anchor base assembly 351, a mid swivel bracket assembly 400, an end swivel bracket assembly 450, module clamps 500 and 900, and other components not depicted. Each of these will be described in more detail in the following descriptions of the figures.

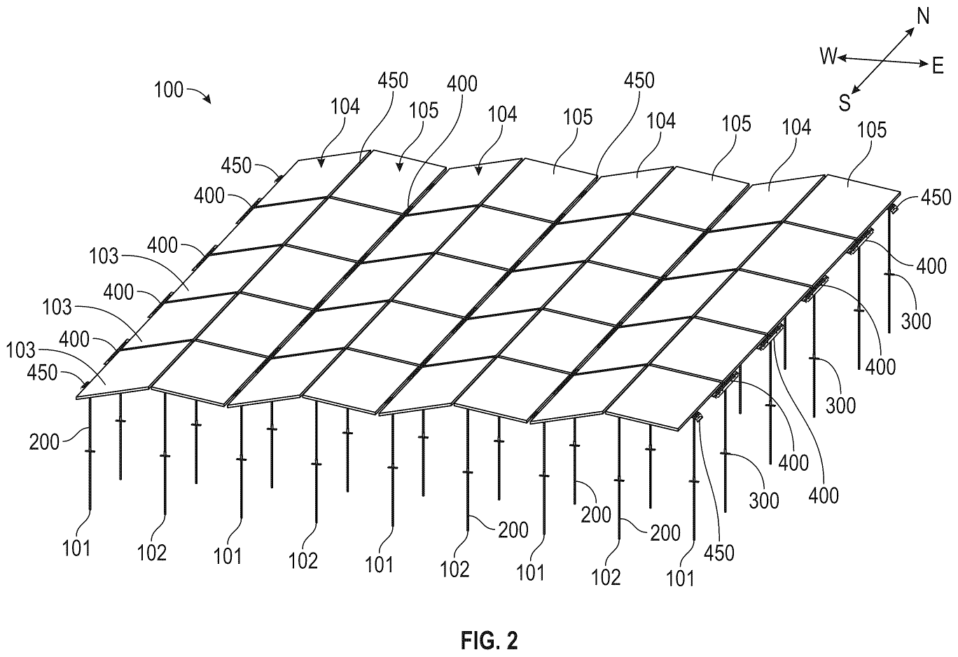

FIG. 2 depicts an isometric view of solar module array 100. Solar module array 100 may consist of a plurality of micropiles 200 arranged in columns and rows, with a plurality of solar modules 103 connected to the micropiles 200 on mid swivel bracket assemblies 400 and/or end swivel bracket assemblies 450. The micropiles 200 may be arranged in one or more short micropile columns 101 and tall micropile columns 102 as depicted, wherein each column is substantially aligned along a north-nouth direction. The plurality of solar modules 103 may be arranged in one or more columns of west-facing solar modules 104 and east-facing solar modules 105, the solar module columns likewise being substantially aligned along a north-south direction. As depicted, the columns of solar modules 103 may alternate between west-facing solar modules 104 and east-facing solar modules 105, but in other example embodiments, short micropile columns 101 and tall micropile columns 102 may be arranged so that a solar module array 100 has more than more than one column of west-facing solar modules 104 adjacent to one or more columns of east-facing solar modules 105. Other example embodiments could include two or more columns of west-facing solar modules 104, followed by alternating columns of east-facing solar modules 105 and west-facing solar modules 104, followed by two or more columns of east-facing solar modules 105.

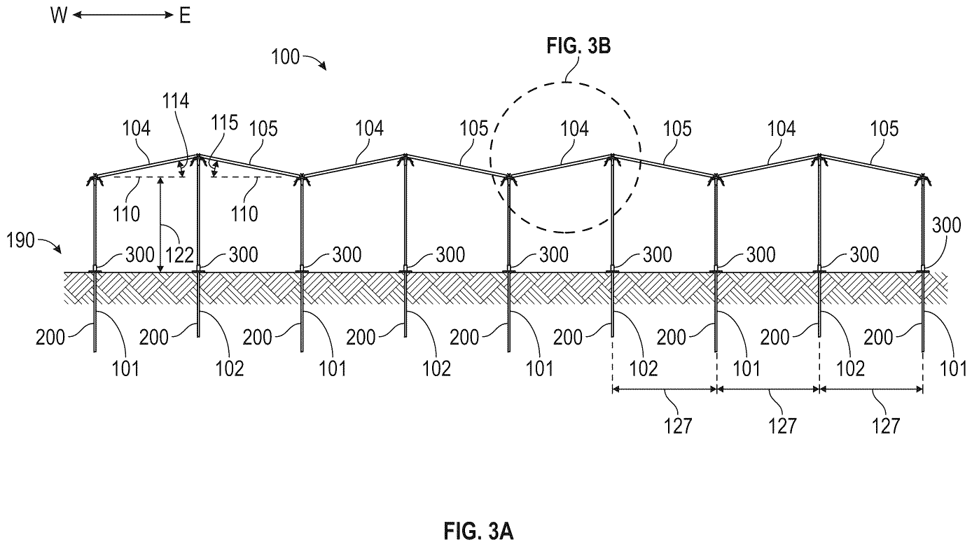

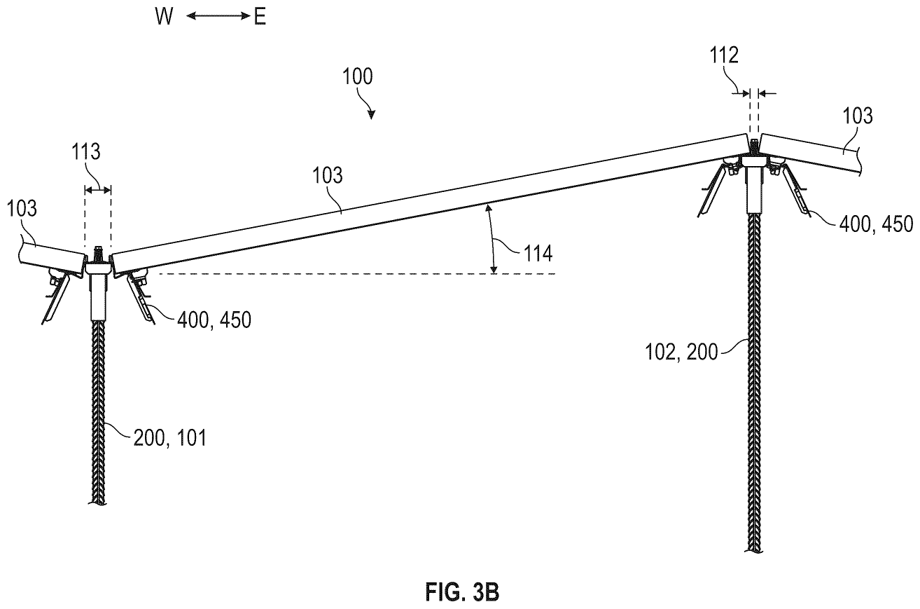

FIG. 3A depicts a side view of solar module array 100 looking towards north, the view being from the south side of the array. As depicted, all micropiles 200 within the solar module array 100 may have substantially the same length, but installed in the terrain 190 to different depths such that the resulting heights (known as “reveals”) of the skyward distal ends of various micropiles 200 above the terrain 190 are different. In other example embodiments, the micropiles 200 may have two or more length configurations, such that the reveals may be different between a short micropile column 101 and a tall micropile column 102, but the installed depths of the micropiles 200 below the surface of the terrain 190 may be substantially similar. In yet another example embodiment, a short micropile column 101 or a tall micropile column 102 may be installed a distance into terrain 190 such that the distal ends of all the micropiles 200 within a respective short micropile column 101 or tall micropile column 102 are substantially aligned to a first elevation even if the terrain 190 is undulating, uneven, or sloped.

Adjacent micropile columns may be spaced apart in the east-west direction by a micropile spacing 127. The east-west micropile spacing 127 may be equal to the solar module width 126 plus the width of a peak gap 112 or trough gap 113, both shown in FIG. 3B. This can result in the solar modules 103 being substantially parallel with the terrain 190, and the short micropile columns 101 and tall micropile columns 102 being at substantially the same elevation above the terrain 190. As depicted in FIG. 3A, the east-west micropile spacing 127 may be less than the combination of the solar module width 126 and the peak gap 112 or trough gap 113, resulting in the solar module 103 being at a west module tilt angle 114 or east module tilt angle 115 relative to the horizon 110. As an example embodiment of a solar module array 100, adjacent columns of micropiles 200 may be positioned with an east-west micropile spacing 127 and with upper ends at different elevations above the horizon 110, such that a first column of solar modules 103 installed on the first and second columns of micropiles 200 may be at a west module tilt angle 114. In some embodiments, this first column of solar modules 103 may be facing within 45deg of due west. In other words, the column of micropiles may be aligned within an azimuth of 45degrees to North. A third column of micropiles 200 may be positioned with an east-west micropile spacing 127 apart from the second column of micropiles 200 and installed as a short micropile column 101. In this way, the second column of solar modules 103 may be at an angle to the horizon 110 that is opposite to the angle of a west-facing solar module 104, and as such would be an east-facing solar module 105. In some example embodiments, the west module tilt angle 114 and the east module tilt angle 115 may be equal and opposite angles relative to the horizon 110, and in other examples, these angles may be different from each other. In some example embodiments, the first and second column of west-facing solar modules 104 (for example, the first and third columns of the solar module array 100 in the depiction) may have different west module tilt angles 114, and the first and second columns of east-facing solar modules 105 (for example, the second and fourth columns of the solar module array 100 in the depiction) may have different east module tilt angles 115. The west module tilt angle 114 and east module tilt angle 115 may range from zero to twenty degrees, and in some cases between five and twelve degrees.

The skyward distal ends of the short micropile columns 101 may be above the terrain 190 by an array-to-terrain clearance 122. The array-to-terrain clearance 122 may be between twenty to fifty inches, a distance enough for a person to crawl under one or more installed solar modules 103. The array-to-terrain clearance 122 may vary at each micropile 200 depending on the undulations and unevenness of the terrain 190. The array-to-terrain clearance 122 may be shorter at the west and east short micropile columns 101 and/or the tall micropile columns 102 compared to the short micropile columns 101 and tall micropile columns 102 in the middle of the solar module array 100, the difference in height serving to more readily deflect wind above the array.

FIG. 3B is a close-up side view of the solar module array 100 shown in FIG. 3A. As shown, adjacent solar modules 103 on a mid swivel bracket assembly 400 or an end swivel bracket assembly 450 on a short micropile column 101 may be spaced apart by a trough gap 113. The trough gap 113 may be between zero and one hundred millimeters and configured to have sufficient space to allow debris and snow to pass through. Likewise, adjacent solar modules 103 on a mid swivel bracket assembly 400 or an end swivel bracket assembly 450 on a tall micropile column 102 may be spaced apart by a peak gap 112. The peak gap 112 may be between zero and one hundred millimeters, and in other examples between five and fifty millimeters. In some cases, the peak gap 112 may be less than the trough gap 113, as depicted, and in other example embodiments, the peak gap 112 may be equal to or greater than the trough gap 113. The peak gap 112 may be configured to allow sufficient airflow to reduce upwards wind pressure by twenty-five percent or more of what the pressure would be without a peak gap. The peak gap 112 may also be configured to allow passage of a tool, such as a screwdriver or socket driver.

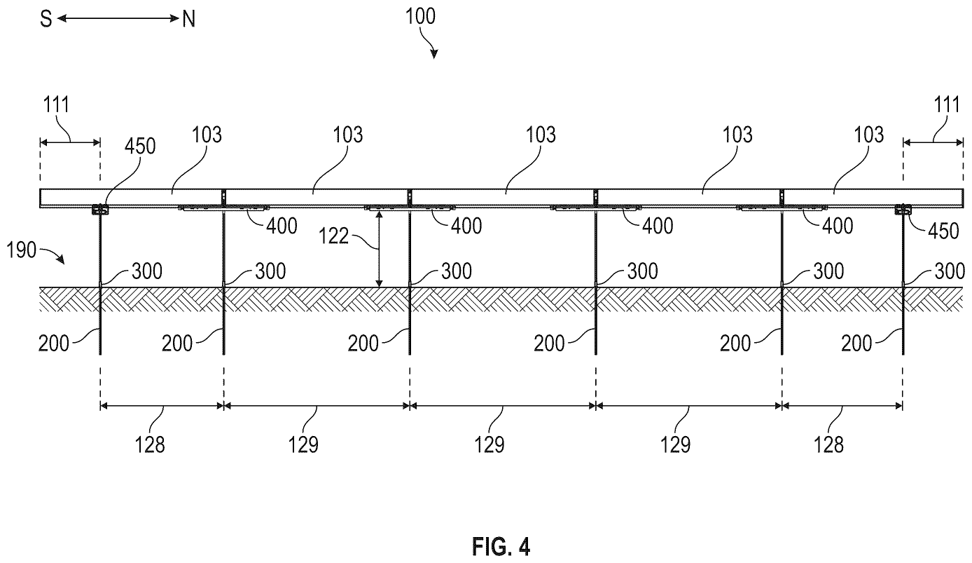

FIG. 4 depicts a side view of a solar module array 100 looking towards the west, the view taken from the east side of the array. Micropiles 200 may be arranged in substantially linear rows, where the first and second micropile columns and the last and second-to-last micropile columns are spaced apart by a north-south spacing 128, and the spacing between adjacent micropile columns extending from the second column to the second-to-last column can be referred to as mid north-south spacings. In some example embodiments, the end north-south spacings and the mid north-south spacings are the same, and in other examples, as depicted, the end north-south spacings are less than the mid north-south spacings. The mid north-south spacings 129 may be equal to solar module length 123 plus any north-south gap. The end north-south spacing 128 may be less than the mid north-south spacing 129 so that the first and last micropiles 200 within a short micropile column 101 or a tall micropile column 102 are positioned inwards from the edge of a first and last solar module 103 by module cantilever range 111.

In other example embodiments not shown, the solar modules 103 may be rotated 90 degrees and installed in a portrait orientation, rather than a landscape orientation as depicted.

In some example embodiments, the solar module array 100 may be configured with an equal number of columns of west-facing solar modules 104 and columns of east-facing solar modules 105, such that the west-most column of solar modules 103 are west-facing solar modules 104 and the east-most column of solar modules 103 are east-facing solar modules 105. In some example embodiments, each solar module 103 may have a maximum production voltage which is the maximum voltage that a single solar module 103 may produce and be rated to a maximum system voltage which is the maximum voltage capacity when a plurality of solar modules 103 are connected electrically in series. A column of west-facing solar modules 104 or a column of east-facing solar modules 105 may have a quantity of solar modules 103 equal to or less than the maximum system voltage divided by the maximum production voltage. For example, if a solar module 103 has a maximum production voltage of 49.8 volts, and a maximum system voltage of 1 module lifter 500 volts, then 1 module lifter 500 divided by 49.8 volts equals 30.12, which rounds down to thirty solar module 103 electrically connected in series for a column of west-facing solar modules 104 or a column of east-facing solar modules 105. Columns of west-facing solar modules 104 in a solar module array 100 may be electrically connected in parallel to a first electrical inverter, thereby maintaining the total voltage of column of west-facing solar module 104 but increasing the amperage delivered to the first inverter. Likewise, a column of east-facing solar modules 105 in a solar module array may be electrically connected in parallel to a second electrical inverter, thereby maintaining the total voltage of each column of east-facing solar modules 105 but increasing the amperage delivered to the second inverter. A solar module array 100 may have a quantity of columns of west-facing solar modules 104 electrically connected in parallel to deliver a desired maximum amperage, which may be limited to the maximum amperage capacity of an inverter. In other example embodiments where the quantity of solar modules 103 in a column of west-facing solar modules 104 does not exceed the maximum system voltage of a solar module 103, a first column of west-facing solar modules 104 may be electrically connected in series to a second column of west-facing solar modules 104. For example, using the previously stated voltage capacities, a first column of west-facing solar modules 104 with fifteen solar modules 103 may be electrically connected in series to a second column of west-facing solar modules 104 with fifteen solar modules 103 to maximize the potential voltage produced while not exceeding the maximum voltage capacity of solar module 103.

In some example embodiments, bifacial solar modules are used, producing electricity from light hitting both the front and back surfaces of the module. In other example embodiments, mono-facial solar modules are used. A solar module 103 may include mono-crystalline, poly-crystalline, or thin-film photovoltaic technology. The solar module 103 may have an aluminum frame pre-installed on all four sides of the photovoltaic laminate, or the solar module 103 may have no external frame, and be made from two pieces of glass laminated together encapsulating a plurality of photovoltaic cells or a deposition of photovoltaic material.

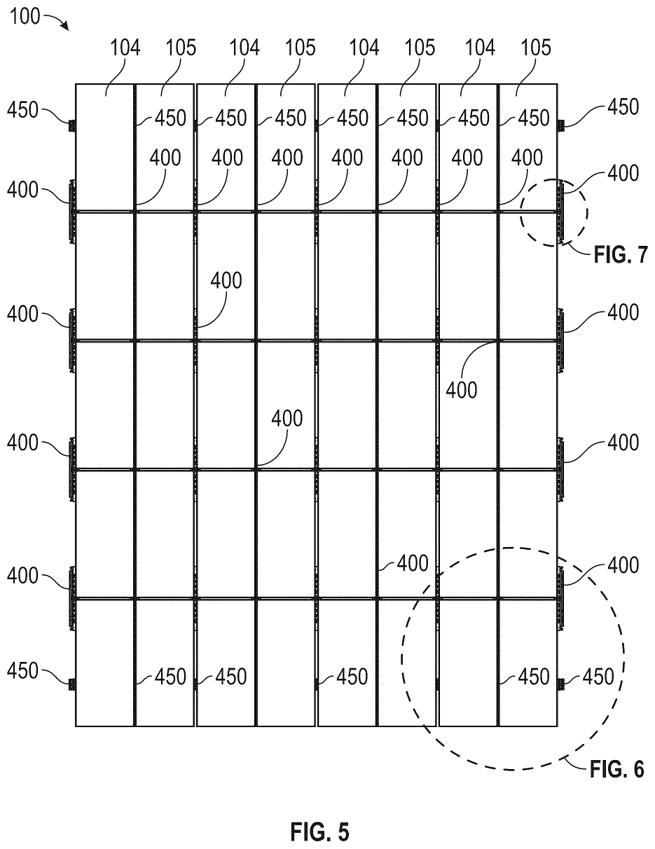

FIG. 5 depicts a top-down view of a solar module array 100, representing one example embodiment of the present invention.

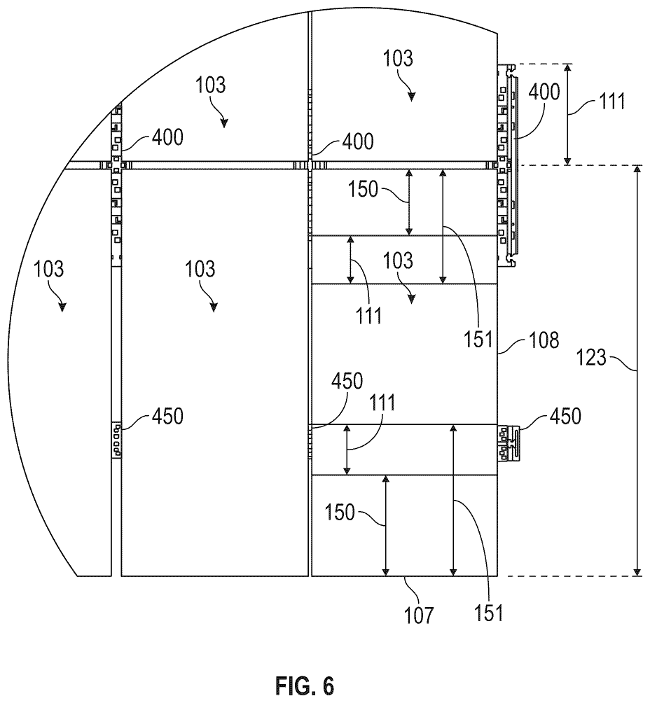

FIG. 6 is a top-down close-up view of a corner of the solar module array 100, as indicated in FIG. 5, representing one example embodiment of the present invention. The solar module 103 may have a short edge 107 and a long edge 108. In some example embodiments, the short edge 107 may be between nine-hundred and fifteen hundred millimeters in length, and the long edge 108 may be between 1700 and 3000 millimeters in length. A 111 is defined as the range between Minimum module cantilever range 150 and Maximum module cantilever range 151, which are both measured from 107 along the long edge 108. Minimum module cantilever range 150 may be a distance of zero to ten percent of solar module length 123, and Maximum module cantilever range 151 may be a distance of twenty to forty percent of solar module length 123, resulting in a module cantilever range 111 of zero and forty percent of the solar module length 123, and in some cases, between fifteen and thirty-five percent of solar module length 123, as measured from the short edge 107. As shown in FIG. 4, a micropile 200 may be positioned so that the centerline of an end swivel bracket assembly 450 is positioned within the module cantilever range 111. The mid swivel bracket assembly 400 may be of a length such that it extends under a solar module 103 by a distance equal to or greater than Minimum module cantilever range 150, as depicted.

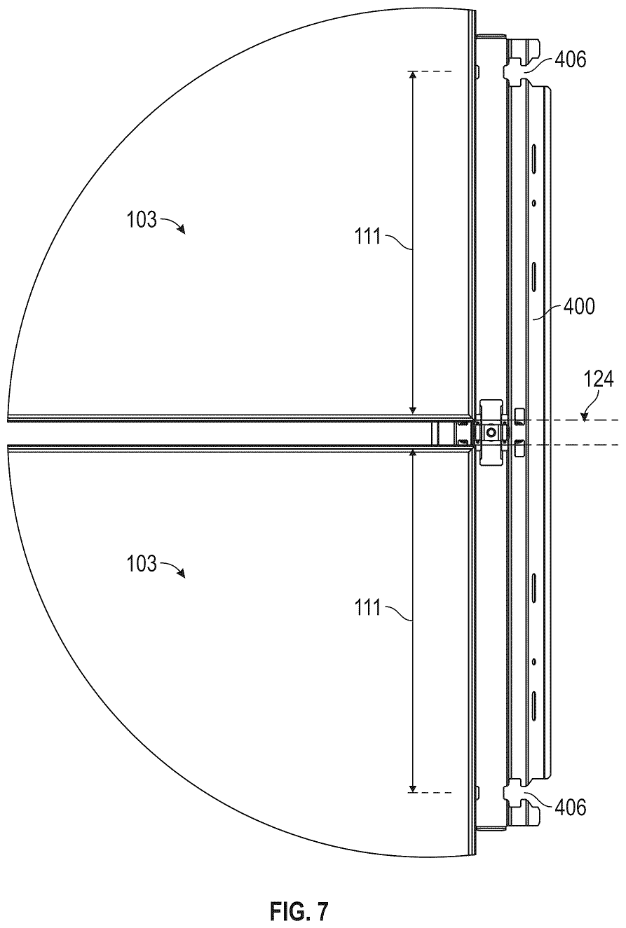

FIG. 7 is a top-down close-up view of FIG. 5 centered over two solar modules 103 installed onto a mid swivel bracket assembly 400, representing one example embodiment of the present invention. In this example, the mid swivel bracket assembly 400 may have a length so that the centerline of the module clamp attachment location 406 is positioned within the module cantilever range 111. A module clamp 500 may secure a solar module array 100 to a mid swivel bracket assembly 400 at the position of the module clamp attachment location 406. A north-south gap 124 is shown between the edges of a first solar module 103 and a second solar module 103. The north-south gap 124 may be between zero and 100 millimeters, and in some cases may be between ten and thirty millimeters. The north-south gap 124 may be substantially the same throughout solar module array 100. The north-south gap 124 may be configured to reduce the uplift wind pressure by more than twenty-five percent.

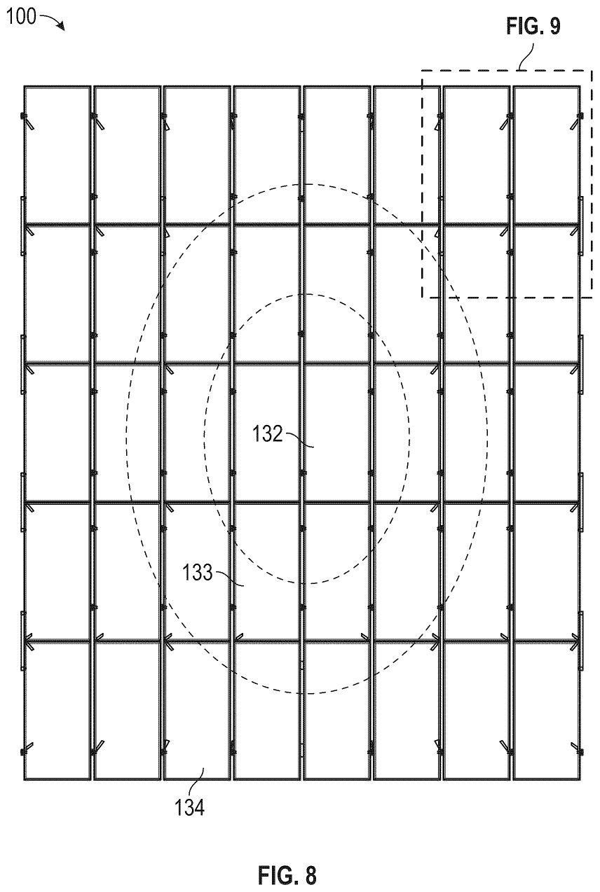

FIG. 8 depicts a top-down view of a solar module array 100 indicating zones of differing wind forces applied to solar module array 100. Zone one 132 may form a circular, rectangular, or ovular shape substantially around the center of the solar module array 100 and may be aligned with the edges of a connected series of solar modules 103.

The boundary of zone one may bisect any number of solar modules 103 as depicted. Zone two 133 may reside around the perimeter of zone one in a circular, rectangular, or ovular shape, and may be aligned with the edges of a connected series of solar modules 103, and it may bisect any number of solar modules 103 as depicted. Zone three 134 may reside in an area surrounding the perimeter of zone two 133. Wind forces may impose a pressure on solar modules 103 at various levels in zone one 132, zone two 133, and zone three 134. A first pressure may be imposed on zone one 132, a second pressure greater than the first pressure may be imposed on zone two 133, and a third pressure greater than the second pressure may be imposed on zone three 134. In other example embodiments, a plurality of pressures may be imposed on the solar module array 100, with the lowest pressure substantially near the center of solar module array 100, and pressures incrementally increasing to a highest pressure substantially near the perimeter of solar module array 100, thereby creating a pressure gradient across the solar module array 100.

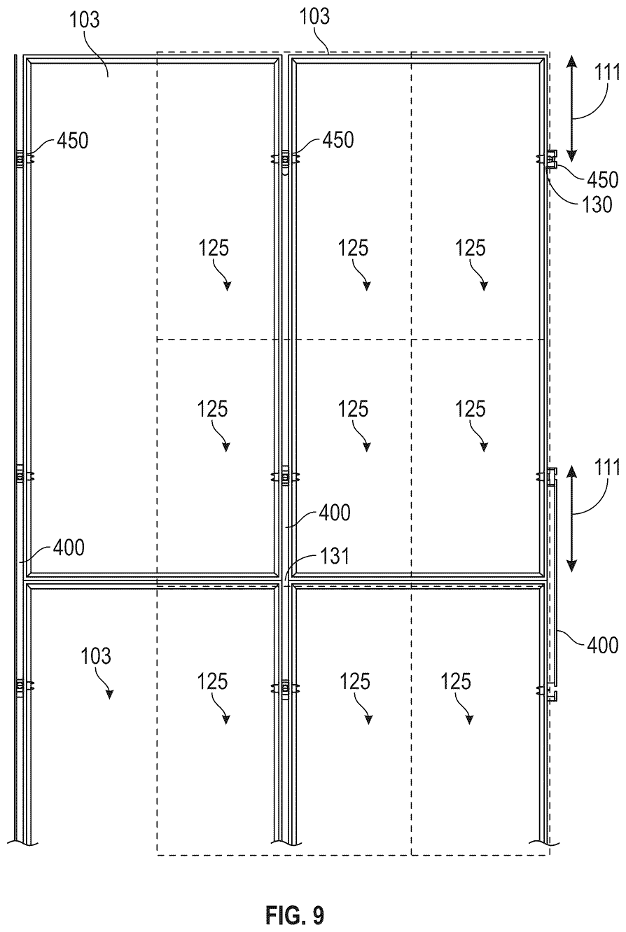

FIG. 9 is a top-down view of a corner of a solar module array 100, representing one example embodiment of the present invention. To determine the force a given micropile 200 may be required to withstand, a solar module 103 may be divided into four tributary area quadrants 125. The pressure from wind loading may be multiplied by the area of the tributary area quadrants 125 that are associated with a given micropile 200. For example, a micropile at a corner of the array may be subject to a wind force equal to the wind pressure on a first tributary area quadrant 125 multiplied by the area of that single tributary area quadrant 125. An inside-corner micropile may be subject to a wind force equal to the wind pressure on the four adjacent tributary area quadrants 125 multiplied by four times the area of tributary area quadrant 125. As such, the wind force applied to an inside-corner micropile 131 may be greater than the wind force applied to a corner micropile 130. Inside-corner micropile 131 may be defined as the micropile 200 that is located along an interior side of a solar module, such as one row and one column inwards from an exterior row or exterior column of micropiles. For example, the inside-corner micropile may be at location row-two, column-two.

Multiplying the tributary surface area by the pressure or pressure gradient in that specific tributary surface area will render an upward or downward force applied to a micropile 200 due to wind pressure. In some example embodiments, a micropile 200 located in a high pressure location such as zone three 134 or zone two 133 may be installed in the terrain to a greater depth or secured to the terrain by a different method than a micropile located in a lower pressure location, such as zone one 132. For example, a micropile 200 located in a high pressure location such as zone three 134 may be threaded or may be an auger, toggle, or other apparatus to increase the pullout force from the terrain in order to meet the increased pressure on the solar modules in that high pressure location. In other words, a micropile 200 in a high pressure location may be installed in the terrain in a more secure way, such as to a deeper depth or with an anchor apparatus, compared to a micropile 200 in a lower pressure location. Across the pressure gradient of the solar array 100, micropiles 200 may be installed at various depths in the terrain, or with or without an anchor apparatus, to provide resistance to the various forces imposed on individual micropiles.

Additionally, micropiles 200 that have less tributary area from attached solar modules 103 may be installed to a shallower depth or without additional anchors compared to micropiles 200 supporting all four tributary area quadrants 125, as discussed in regard to FIG. 9. For example, an inside-corner micropile 131 may require an increased pullout force from the terrain 190 compared to a corner micropile 130. In other example embodiments, an additional micropile 200 and a mid swivel bracket assembly 400 and/or an end swivel bracket assembly 450 may be installed and connected to solar modules located in high pressure areas, such as the solar modules in corner locations of the solar module array shown in FIG. 9.

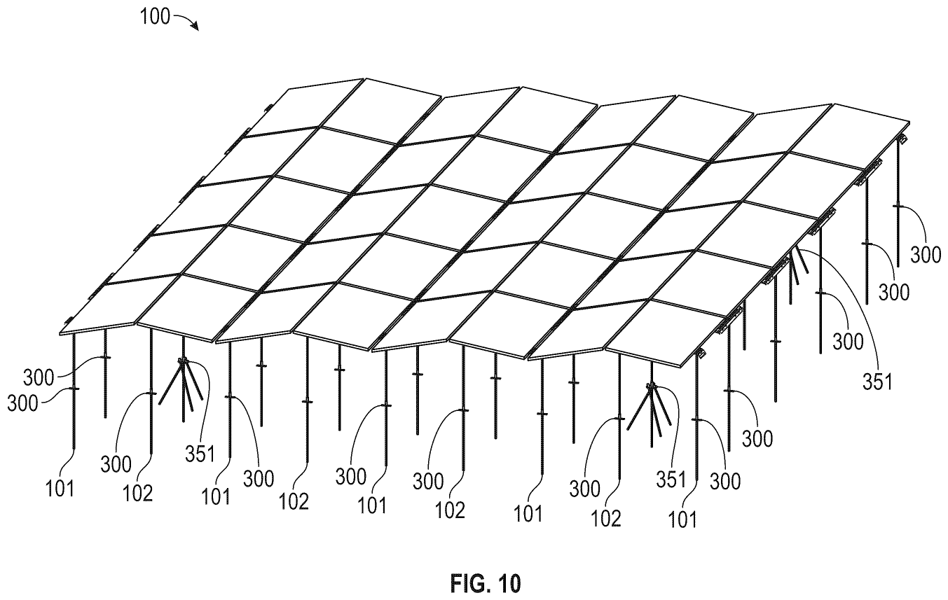

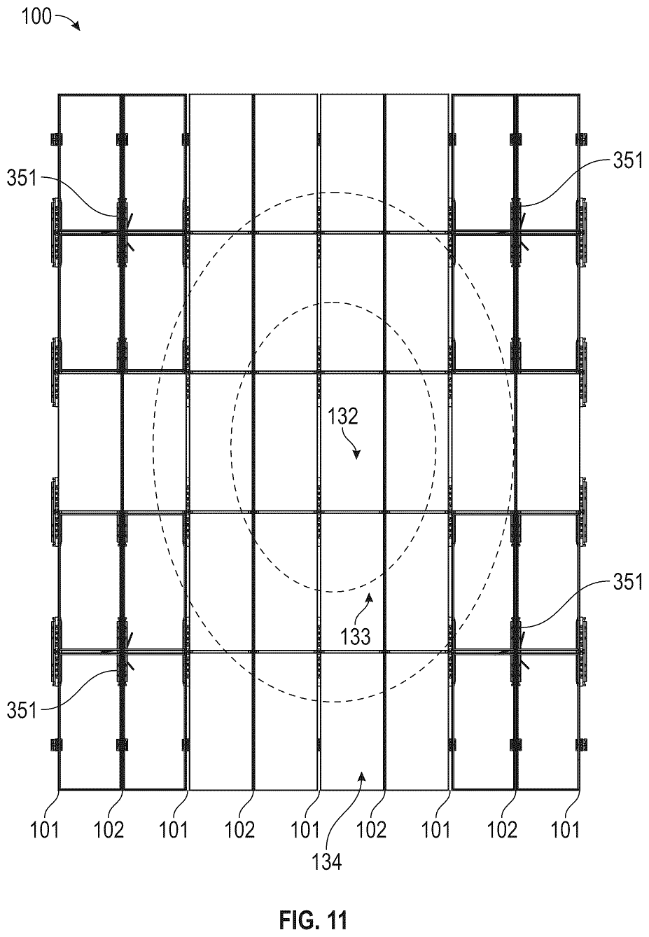

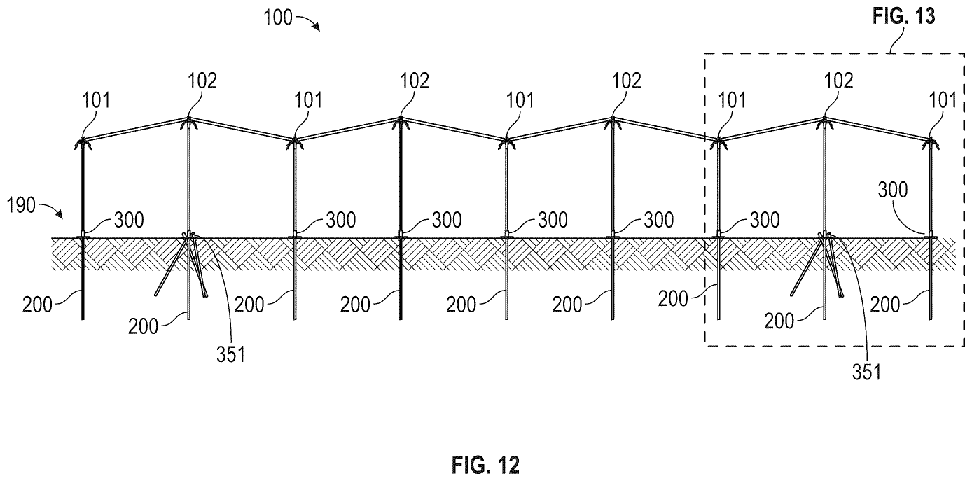

FIGS. 10 to 12 depict various views of a solar module array 100 with one or more anchor base assemblies 351 installed on micropiles 200 that are subject to higher loads, representing one example embodiment of the present invention. FIG. 10 is an isometric view of a solar module array 100, exemplifying a potential location for use of an anchor base assembly 351 installed onto a micropile 200. FIG. 11 is the same example as FIG. 10 but depicted as a top-down view. FIG. 12 is a side plan view looking towards north depicting the use of a plurality of anchor base assemblies 351 on micropiles 200. In FIG. 12, the four outermost micropiles 200 each have the highest sum of tributary area quadrants 125 within zone three 134 (FIG. 8). As such, these four micropiles 200 are subject to the most positive and negative vertical forces (from wind or snow, for example) and are determined to require additional force capacities compared to other micropiles 200 within the solar module array. Therefore, an anchor base assembly 351 is installed next to each of these four micropiles 200, for example on the second row in from the northernmost or southernmost edge of the solar array, instead of a base 300 to provide additional resistive force capacity. In fact, an anchor base assembly 351 may be installed instead of a base 300 on any micropile 200 that is deemed to require additional resistive force capacity. For example, a plurality of micropiles 200 may all have associated tributary area quadrants 125 within zone three 134, and may this necessarily require anchor base assemblies 351 installed instead of bases 300 to increase the resistive force capacities of these micropiles. In some cases, only those micropiles within a tall micropile column 102 may have an anchor base assembly 351 installed instead of a base 300. The resistive force capacity in a skyward direction of an anchor base assembly 351 when installed in a terrain 190 may be greater than 1000 pounds-force.

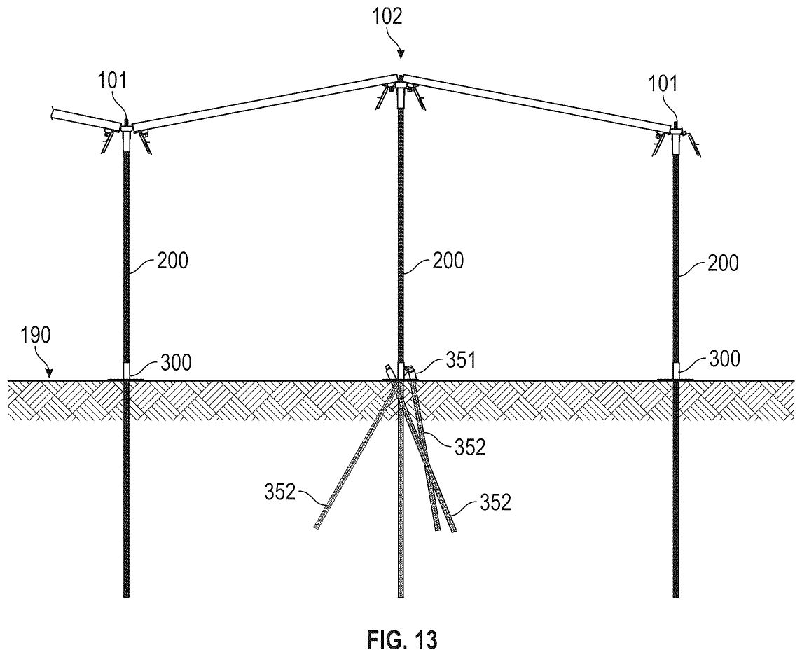

FIG. 13 is a close-up view of FIG. 12, detailing the aspects of an anchor base assembly 351, representing one example embodiment of the present invention. As shown, the anchor base assembly 351 may comprise an anchor base 350 with one or more anchor base micropiles 352 driven into the terrain 190. The anchor base 350 may be installed onto the micropiles in the same manner as the other bases 300, and the anchor base micropiles 352 may then be installed into the terrain. The micropiles 200 other than the anchor base micropiles may extend further into the terrain 190 than the anchor base micropiles 352 as depicted, or the one or more anchor base micropiles 352 may extend further than the non-anchor micropiles 200. The one or more anchor base micropiles 352 may be installed at an angle relative to the non-anchor micropiles 200 in order to increase the resistive force from a vertically upward force.

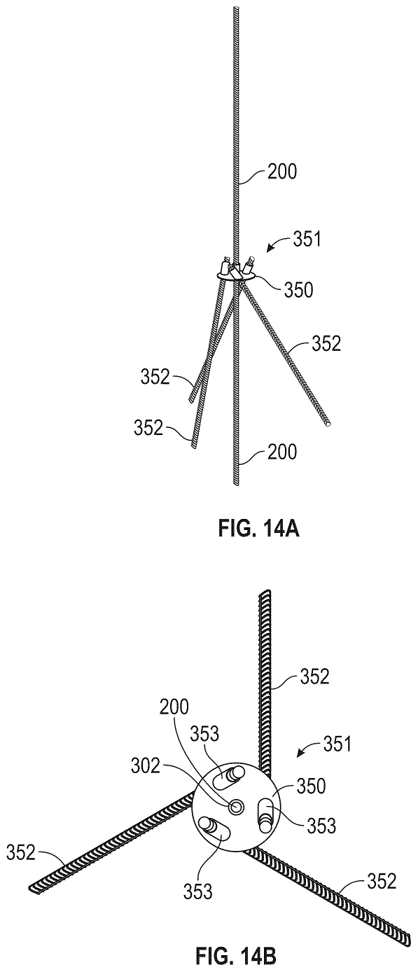

FIGS. 14A and 14B are isometric and top-down views, respectively, of an anchor base assembly 351 where the adjacent componentry is removed for ease of depiction of the anchor base assembly. As depicted, a plurality of anchor base clamp tubes 353 may be arranged on the anchor base 350, each clamp tube configured to receive and secure an anchor base micropile 352. The anchor base clamp tubes 353 may be configured in a circular pattern around a base crimp tube 302 and the anchor base 350, and at a positive angle relative to the vertical in order to increase the projected area of an anchor base micropile 352 when viewed from above (such as in FIG. 14B). In other example embodiments not shown, an anchor base clamp tube 353 may be configured in a linear pattern across the anchor base 350, and may or may not be at an angle relative to the base crimp tube 302. In all cases, the anchor base assembly 351 may be configured to receive and secure at least one anchor base micropile 352 and one non-anchor base micropile 200 in order to provide an additional upwards resistive force greater than a micropile 200 on its own. For example, a micropile 200 with an anchor base assembly 351 installed, upon installation into the terrain, may resist up to 2000 pounds force in the upwards vertical direction. In some cases, only the quantity of anchor base micropiles 352 needed to provide the desired resistive force may be used, leaving some anchor base clamp tubes 353 vacant. For example, an anchor base 350 may have four anchor base clamp tubes 353 available, with anchor base micropiles installed in only two of the tubes.

An anchor base clamp tube 353 may be a tube configured to be crimped, pinched, or deformed onto an anchor base micropile 352 in a way to prevent the anchor base micropile 352 from dislodging. Alternatively, an anchor base clamp tube 353 may have one or more fasteners used to secure the tube to an anchor base micropile 352. The anchor base clamp tube 353 may be welded or crimped to the anchor base 350. Anchor base clamp tubes 353 and anchor bases 350 may be steel, aluminum, or other suitable material, and may have a coating to protect against corrosion, such as by galvanization, anodization, paint, or a powder coat. In some examples, an anchor base may have an insulating layer on its underside to protect the anchor base from the terrain. The insulating layer may be a tape, rubber, plastic, paint, or other material.

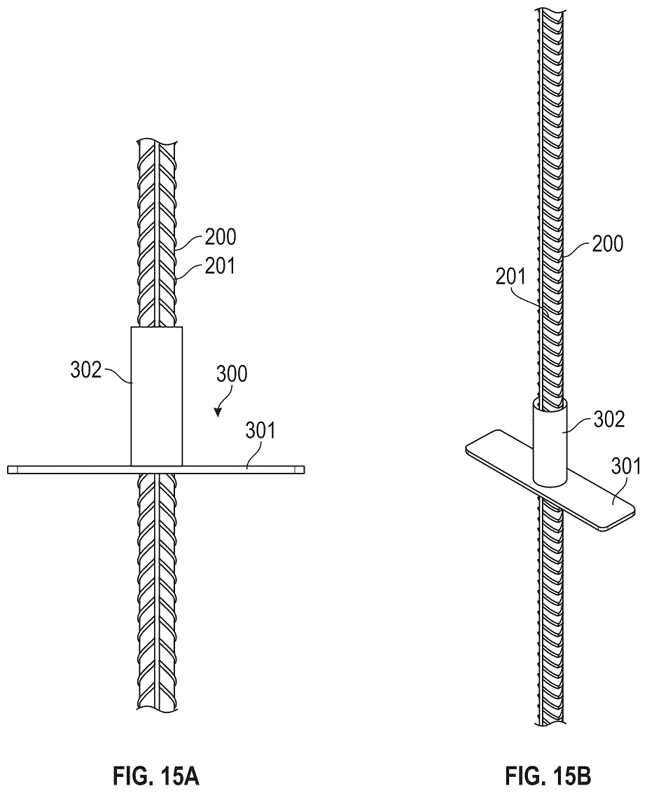

FIGS. 15A and 15B depict plan and isometric views respectively of a base 300 installed on a micropile 200, representing one example embodiment of the present invention. The base 300 may consist of a base crimp tube 302 and a base plate 301, which may be joined by crimping, welding, machining, a screw connection, or other mechanical connection. The micropile 200 may have a plurality of ribs 201 disposed on its surface. The base crimp tube 302 may be an aluminum or steel material with a thickness between 1.5 and 3 millimeters, and an inside diameter of between 15 and 25 millimeters. The base plate 301 may also be of aluminum or steel and configured to have a length different than its width. Both the base crimp tube 302 and the base plate 301 may each have a uniform thickness. The base crimp tube 302 may be configured to be crimped and secured to the micropile 200 to prevent the micropile 200 from sliding through base crimp tube 302 after crimping. The crimped connection may be configured to withstand 500 or more kilograms of force before breaking free.

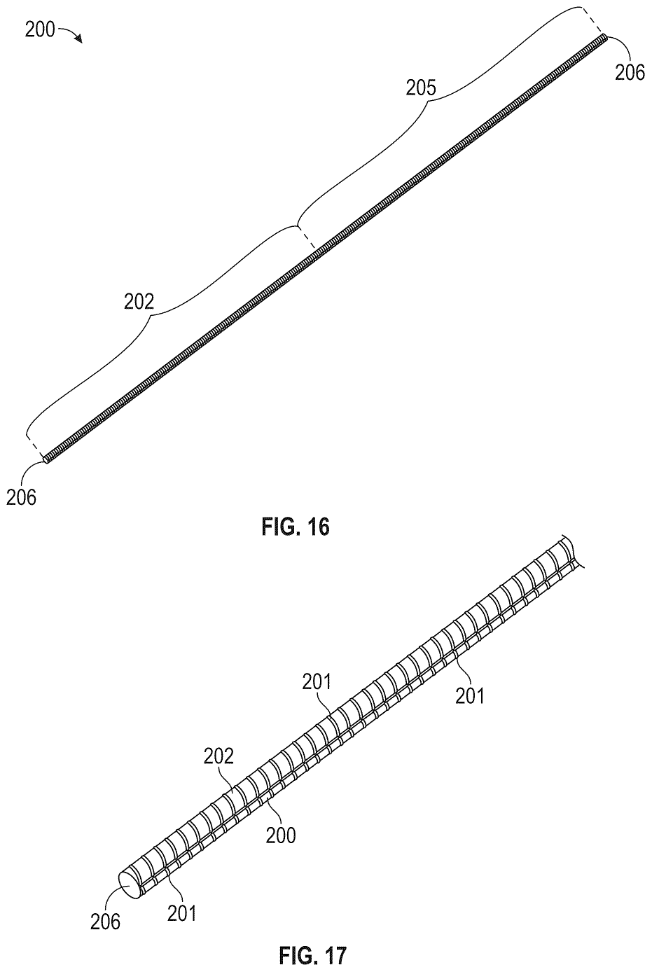

FIG. 16 depicts an isometric view of a micropile 200, representing one example embodiment of the present invention. Both ends of this micropile are configured as flat tips 206. The micropile is divided into two sections, one with a protective coating 202 and the other bare 205. In some embodiments, the protective coating 202 may span the entire length of the micropile 200 without a bare section 205, and in other embodiments, the bare section 205 may span the entire length of the micropile 200 with no protective coating 202. In other embodiments, the protective coating 202 may span a first 60% of the micropile length, or it may span a limited distance so that the protective coating 202 extends between zero and 250 millimeters above the terrain when the micropile 200 is installed into the terrain. The protective coating 202 may be a galvanized coating, a paint, a powder coat, an epoxy coat, anodization, a combination thereof, or other suitable protective coating. In some embodiments, the protective coating 202 may be a zinc coating of between 30 and 275 grams per square meter.

In FIG. 17 the micropile 200 contains a plurality of ribs 201 disposed on the micropile surface. The ribs 201 may be angled and semi-circumferential, as shown.

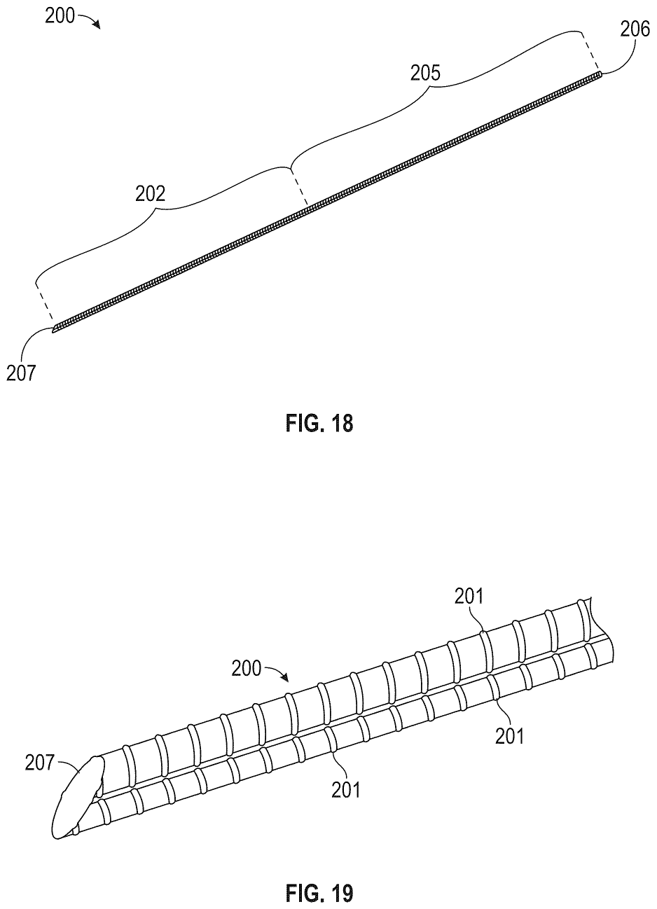

FIGS. 18 and 19 depict an alternative embodiment of a micropile 200, wherein one end of the micropile 200 is configured as an angled tip 207. The angled tip may have a protective coating 202, and the coating may span partially or fully the length of the micropile 200. The bare section 205 may span the entire length of the micropile with no protective coating.

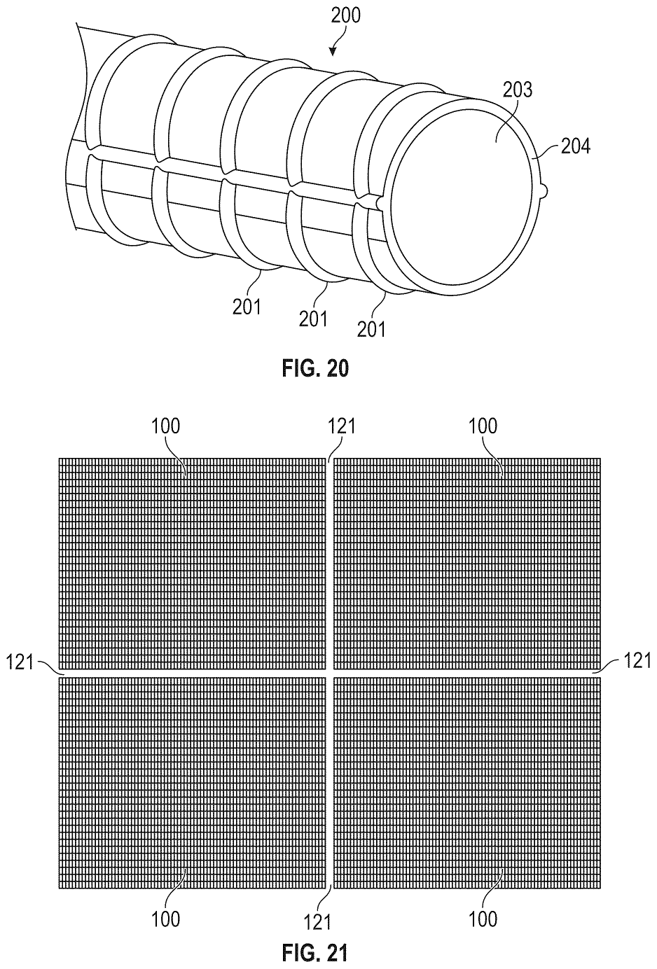

FIG. 20 depicts a close-up isometric view of a distal end of a micropile 200. As shown, the micropile 200 may have a structural core 203 extending the entire length of the micropile 200, the core being encircled by a sacrificial layer 204. In some cases, the sacrificial layer 204 is the same material as the core 203, and is simply configured to act as a sacrificial material while the core 203 is configured to act as a structural material. The micropile 200 may be a carbon steel, an alloy steel, or aluminum. The sacrificial layer 204 may be configured to rust or corrode, thereby providing corrosion protection to the structural core 203 on all sides except for the distal ends. In some embodiments, the structural core 203 may have a diameter of 14-20 millimeters, and the sacrificial layer 204 may have a thickness of 3 to 5 millimeters.

FIG. 21 depicts a top-down view of four installed adjacent solar module arrays 100, representing one example of the present invention. As shown, an array aisleway 121 may separate each adjacent pair of solar module arrays. The array aisleway 121 may be between five and fifty feet wide, and configured to readily allow passage of a work vehicle such as a standard pickup truck between the arrays. In some cases, the array aisleway 121 in the north-south direction may be different in width than the array aisleway 121 along the east-west direction.

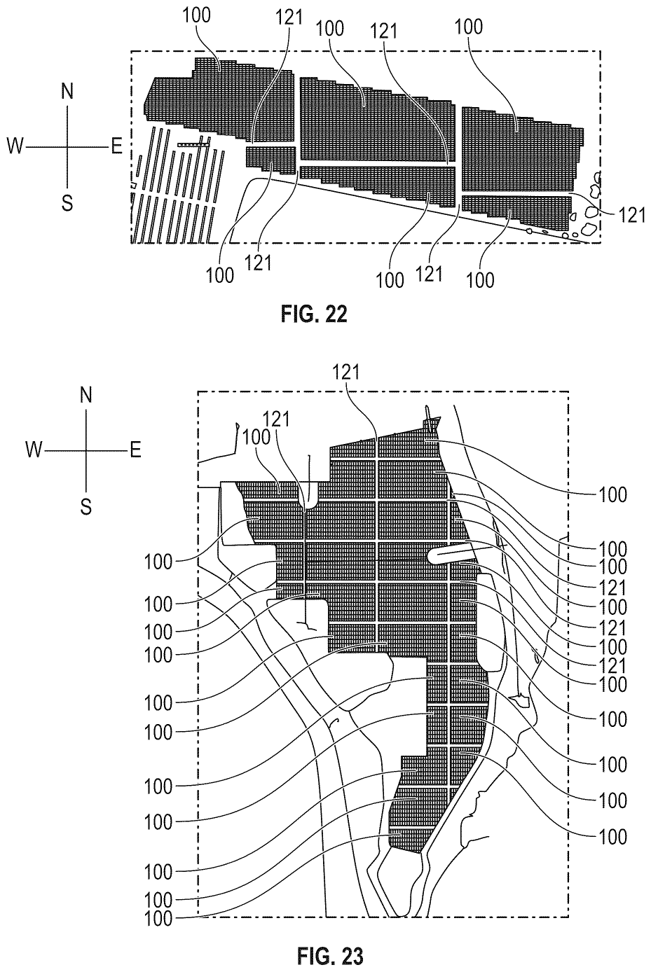

FIGS. 22 and 23 are top-down views depicting other example arrangements of a plurality of solar module arrays, representing other example embodiments of the present invention. As shown in FIG. 22, an array aisleway 121 may extend only the width of a given solar module array 100, where an array aisleway 121 between an adjacent set of solar module arrays is offset. For example, the middle east-west aisleway 121 is offset south of the west-most east-west aisleway 121. FIG. 22 also depicts how each column and row of solar modules within a solar module array 100 may have a different quantity of solar modules and may start or end along a different latitudinal or longitudinal plane. For example, in FIG. 22 the northwesternmost solar module array has a variable amount of solar modules in each column of modules and in many rows. As shown in FIG. 23, multiple solar module arrays 100 may be configured so that adjacent array aisleways are coincident or aligned along latitudinal and longitudinal planes.

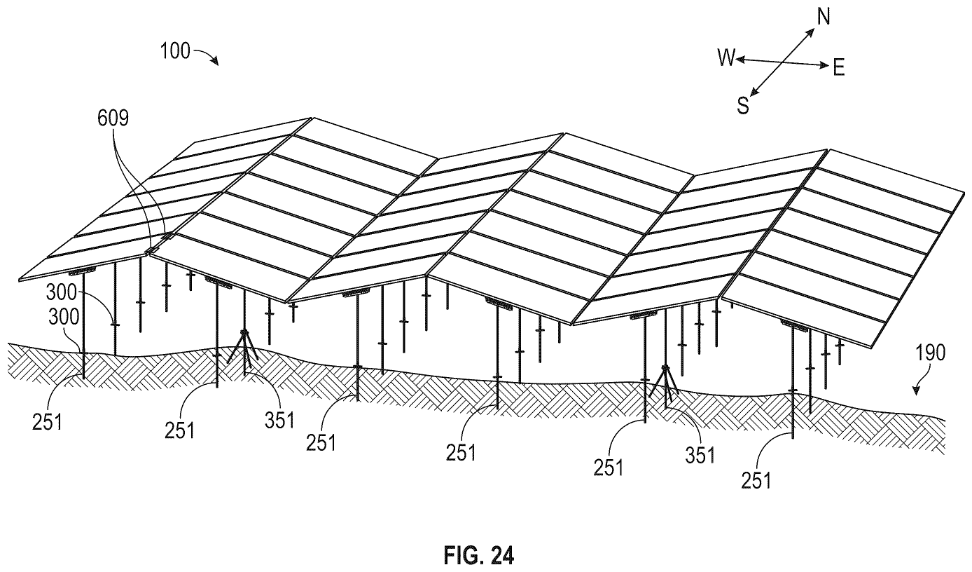

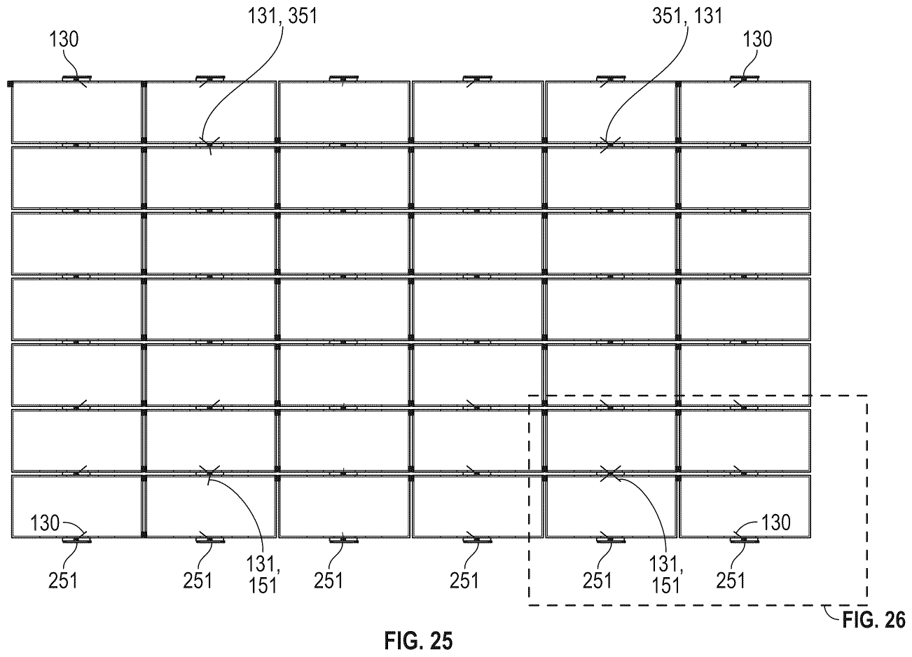

FIGS. 24 through 26 depict various views of the present invention wherein solar modules 103 are installed in a portrait orientation with their long edge 108 substantially aligned East-West. FIG. 24 depicts an isometric view and FIG. 25 depicts a top-down view of solar module array 100 installed into terrain 190 in substantially the same manner as depicted in FIG. 10 and FIG. 11, respectively, however with the solar modules 103 in a portrait orientation with each Micropile column 251 aligned substantially with the centerline the solar modules 103 it supports. At least one Module connector 609 may be installed at the corners of all adjacent solar modules 103 in peak and trough locations to structurally connect and electrically bond adjacent columns of solar modules 103. At least one anchor base assembly 351 may be installed throughout solar array 100 to withstand the location of maximum pressure the solar array 100 is subject to. Anchor base assembly 351 may be installed onto inside-corner micropile 131, which is defined as the micropile 200 located one row and one column inwards from the periphery of the array of micropiles 200, as depicted. Additional anchor base assembly 351 may be installed on other 200 throughout the array of micropiles where the pressure applied to a solar module 103 results in a force greater than the holding force by terrain 190 on a micropile 200 without an anchor base assembly 351 installed.

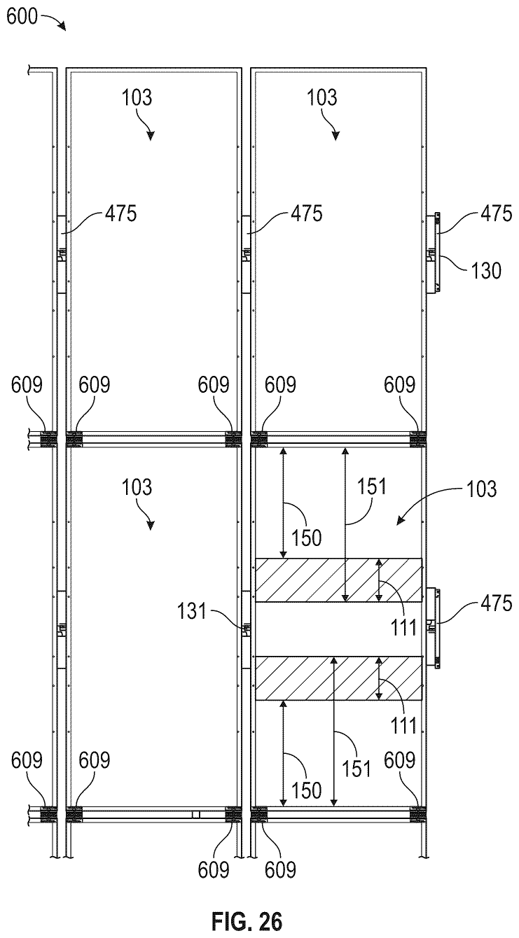

FIG. 26 is a top-down close-up view of a corner of the solar module array 100, as indicated in FIG. 25, representing one example embodiment of the present invention. FIG. 26 is similar to the embodiment described in FIG. 6, however mid swivel bracket 400 and end swivel bracket 450 are both replaced by Center swivel bracket assembly 475. Module cantilever range 111 is defined in the same way as described in FIG. 6. However, center swivel bracket assembly 475 is located substantially at the centerline of solar module long side 108. Center swivel bracket assembly 475 may have a length such that both distal ends extend into both module cantilever range 111 of a single solar module 103. Center swivel bracket assembly 475 may be configured to support a single solar module 103, as shown on the right side of the Figure, or also support two adjacent solar modules 103, as shown in the middle of the figure. At least one module connector 609 may be installed the adjacent corners of solar modules 103 to structurally connect and mechanically bond them together. In some cases, module connector 609 may connect only two corners together, and in other cases module connector 609 may connect four corners together.

In all embodiments, the solar modules may be photovoltaic modules with a glass surface on a top and bottom side encapsulating photovoltaic material, or may have a glass surface only on the skyward side and a polymer material on the underside, the glass and polymer surfaces encapsulating the photovoltaic material.

What is claimed is:

1. A solar module array comprising:
a plurality of different micropiles; and
a plurality of solar modules each subject to different pressures and mounted on a terrain by the micropiles, wherein each of the micropiles supports one or more of the solar modules and is installed in the terrain in accordance with the pressures associated with the respective set of solar modules being supported.

2. The solar module array of claim 1, wherein a first micropile supports a first set of the solar modules that is subject to higher pressures than a second set of the solar modules, and wherein the first micropile is embedded deeper in the terrain than a second micropile supporting the second set.

3. The solar module array of claim 1, wherein a first micropile supports a first set of the solar modules subject to higher pressures than a second set of the solar modules, the first micropile including a base anchor that increases a resistance of the first micropile, and wherein a second micropile supporting the second set lacks a base anchor.

4. The solar module array of claim 1, wherein a first set of the solar modules is subject to higher pressures than a second set of the solar modules, and wherein the first set is supported by a greater number of the micropiles than the second set.

5. The solar module array of claim 1, wherein the solar modules are connected to a micropile using a swivel bracket.

6. The solar module array of claim 1, wherein a micropile located at an inside corner is embedded deeper than an micropile located along an exterior of the solar modules.

7. The solar module array of claim 1, wherein a micropile located at an internal location within an array includes a base anchor to increase a resistance of the internally-located micropile relative to a micropile at a periphery of the array.

8. The solar module array of claim 1, wherein micropiles at an end of a column of the micropiles is positioned within a cantilever range of a long side of one of the solar modules.

9. The solar module array of claim 8, wherein the cantilever range is between zero and forty percent of a length of the solar module.

10. The solar module array of claim 1, wherein micropiles within a middle of a column of the micropiles is positioned between two solar modules.

11. The solar module array of claim 10, wherein the swivel bracket extends a length at least into the cantilever range of the solar module, the cantilever range being between zero and forty percent of the length of the solar module.

12. The solar module array of claim 1, wherein the micropiles are arranged into alternating taller micropile columns and shorter micropile columns, the taller and shorter columns having different heights above the terrain.

13. The solar module array of claim 12, wherein a height difference between a shorter to a taller micropile column results in the solar module being at an angle relative to a horizon of between zero and twenty degrees.

14. The solar module array of claim 12, wherein the micropile columns are aligned within 45 degrees of North direction.

15. A method for installing solar module arrays above a terrain that subjects solar modules to different pressures across the array, the method comprising:
mounting the array to the terrain by a plurality of micropiles, wherein each of the micropiles supports one or more of the solar modules and is installed in the terrain in accordance with the pressures associated with the respective set of solar modules being supported.

16. The method of claim 15, further comprising embedding a first micropile of the micropiles supports a first set of the solar modules that is subject to higher pressures than a second set of the solar modules, and wherein the first micropile is embedded deeper in the terrain than a second micropile supporting the second set.

17. The method of claim 15, further comprising using a base anchor that increases a resistance of a first micropile that supports a first set of the solar modules subject to higher pressures than a second set of the solar modules, wherein a second micropile supporting the second set lacks a base anchor.

18. The method of claim 15, wherein a first set of the solar modules is subject to higher pressures than a second set of the solar modules, and wherein the first set is supported by a greater number of the micropiles than the second set.

19. The method of claim 15, further comprising supporting a first set of the solar modules subject to higher pressures than a second set of the solar modules suing both a swivel bracket and one of the micropiles.

20. The method of claim 15, wherein a micropile located at an inside corner is embedded deeper than an micropile located along an exterior of the solar modules.

21. The method of claim 15, wherein a micropile located at an internal location within the array includes a base anchor to increase a resistance of the internally-located micropile relative to a micropile at a periphery of the array.

22. The method of claim 15, wherein micropiles at an end of a column of the micropiles is positioned within a cantilever range of a long side of one of the solar modules.

23. The method of claim 22 wherein the cantilever range is between zero and forty percent of the length of the solar module.

24. The method of claim 15, wherein micropiles within the middle of a column of micropiles is positioned between two solar modules.

25. The method of claim 24, wherein a swivel bracket extends a length at least into the cantilever range of the solar module, the cantilever range being between zero and forty percent of the length of the solar module.

26. The method of claim 15, wherein the micropiles are arranged into alternating short micropile columns and tall micropile columns, the two types of columns having a different height above the terrain.

27. The method of claim 26, wherein a height difference between a shorter to a taller micropile column results in the solar module being at an angle relative to a horizon of between zero and twenty degrees.

28. The method of claim 15, wherein the micropile columns are aligned within 45 degrees of North direction.
